(19) United States
(12) Patent Application Publication
(10) Pub. No.: US 2009/0300097 A1
(43) Pub. Date: Dec. 3, 2009

(54) SYSTEMS AND METHODS FOR FACILITATING CLIENTLESS FORM-FILLING OVER A NETWORK

(75) Inventor: Jeffrey D. Meyer, Los Gatos, CA (US)

Correspondence Address: Haynes and Boone, LLP;IP Section, 2323 Victory Avenue, SUITE 700, Dallas, TX, 75219, US

(73) Assignee: eBay Inc., San Jose, CA (US)

(21) Appl. No.: 12/128,888

(22) Filed: May 29, 2008

(51) Int. Cl. G06F 15/16

(52) U.S. Cl. 709/203

(57) ABSTRACT

Systems and methods for facilitating clientless form-filling over a network include a first component adapted to communicate with a user via a client device over the network and a service provider via a service provider device over the network and a second component adapted to receive a request to fill a form from the user via the client device over the network and provide the service provider device with information related to the user over the network to fill the form as requested by the user.

### BACKGROUND

1. Field of the Invention

The present invention generally relates to network transactions and more particularly to facilitating clientless form-filling over a network.

2. Related Art

In online services, users are offered products and services through electronic communications with online service providers over communication networks, such as the Internet. During the course of acquiring these products and service, users may be prompted to register with the service provider and fill in common information, such as name, address and other identity information. There are software tools that pre-fill service provider forms. However, these conventional software tools require the customer to purchase and install specific form-fill software on their personal computers to accomplish these tasks.

To some users, purchasing and installing software on their personal computers can be difficult and inconvenient. For example, some user devices may have different operating systems and/or hardware platforms. Thus, there currently exists a need to simplify the process of form-filling in online registration.

### SUMMARY

Systems and methods disclosed herein, in accordance with one or more embodiments, facilitate clientless form-filling over a network by providing a website with a link to another website that holds a user's identity (e.g., a user's personal information). Selecting the link allows a website to fill a service provider's form with a user's information as permitted by the user. In various implementations, this process uses participation of the service provider to add appropriate elements onto their form pages for the user to select the filling operation and to handle subsequent information presented by an identity provider.

In accordance with an embodiment of the present disclosure, a system for facilitating information transactions over a network includes a first component adapted to communicate with a user via a client device over the network and a service provider via a service provider device over the network and a second component adapted to receive a request to fill a form from the user via the client device over the network and provide the service provider device with information related to the user over the network to fill the form as requested by the user.

In various implementations, the second component may be adapted to receive an authentication request from the service provider to authenticate the user information provided the service provider over the network. The second component may be adapted to provide authentication information to the service provider for the user information in response to the authentication request received from service provider.

In various implementations, the service provider device provides the form to the client device via the network. The form includes one or more fields for input of information related to the user. The client device includes a browser application adapted to allow the user to access the service provider device via the network and view the form for input of information related to the user. The system may include a third component adapted to store one or more accounts including a user account related to the user, wherein the user account includes information related to the user.

In accordance with an embodiment of the present disclosure, a method for facilitating information transactions over a network includes communicating with a user via a client device over the network and a service provider via a service provider device over the network, receiving a request to fill a form from the user over the network, accessing a user account related to the user, processing the request by receiving permission from the user to share information related to the user, and completing the request by presenting the selected using identity attributes to the service provider over the network.

In various implementations, the service provider may have an option of requesting confirmation of user identity attributes presented by the identity provider to increase a level of confidence of accuracy of the user information. Accordingly, the method may include receiving an authentication request from the service provider to authenticate the user information provided over the network and providing authentication information to the service provider for the user information in response to the authentication request received from service provider.

These and other features and advantages of the present disclosure will be more readily apparent from the detailed description of the embodiments set forth below taken in conjunction with the accompanying drawings.

### BRIEF DESCRIPTION OF THE FIGURES

FIG. 1 shows a block diagram of a networked system configured to facilitate clientless form-filling in accordance with an embodiment of the present disclosure.

FIG. 2 shows a block diagram of a client-side form filling process, in accordance with an embodiment of the present disclosure.

FIG. 3 shows a block diagram of a server-side form filling process, in accordance with an embodiment of the present disclosure.

FIG. 4 shows a block diagram of a streamlined server-side form filling process, in accordance with an embodiment of the present disclosure.

FIGS. 5A-5C show screenshots of implementing a form-filling process, in accordance with various embodiments of the present disclosure.

FIG. 6 is a block diagram of a computer system suitable for implementing embodiments of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

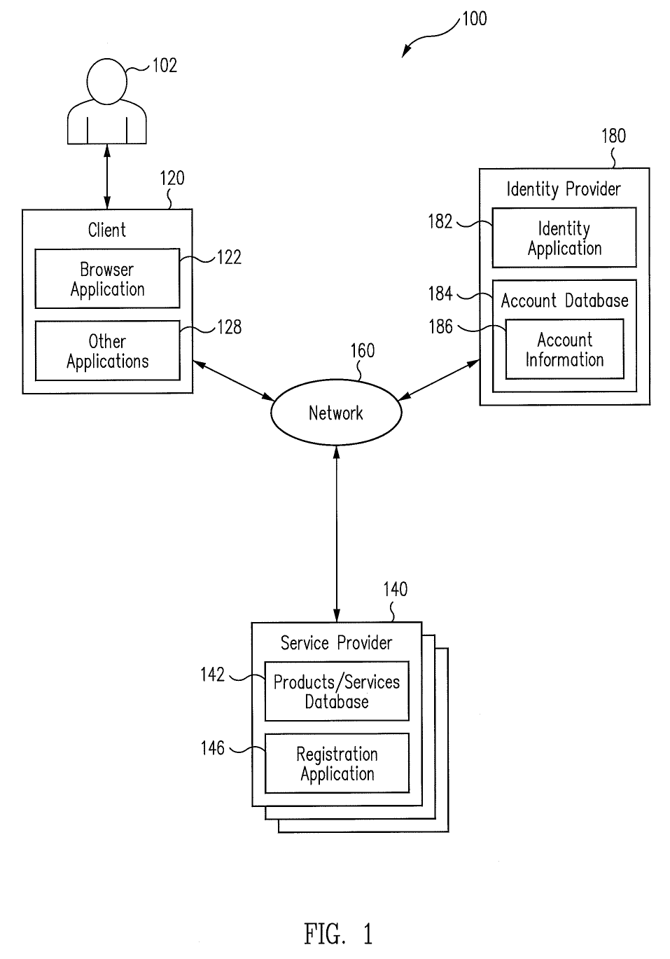

FIG. 1 shows one embodiment of a block diagram of a system 100 adapted to facilitate clientless form-filling over a network 160. As shown in FIG. 1, the system 100 includes at least one client device 120, one or more service provider servers 140, and at least one identity provider server 180 in communication over the network 160.

The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network may comprise a wireless telecommunications network (e.g., cellular phone network) adapted to communicate with other communication networks, such as the Internet.

The client device 120, in one embodiment, may be implemented using any appropriate combination of hardware and/or software configured for wired and/or wireless communication over the network 160. For example, the client device 120 may be implemented as a personal computer of a user 102 (e.g., a client or customer) in communication with the network 160, such as the Internet. In other examples, the client device 120 may be implemented as a wireless telephone (e.g., cell phone), personal digital assistant (PDA), notebook computer, and/or various other generally known types of wired and/or wireless computing devices. It should be appreciated that, in various embodiments, the client device 120 may be referred to as a user device or a customer device without departing from the scope of the present disclosure.

The client device 120, in one embodiment, may include one or more browser applications 122 which may be used to provide a user interface to permit the user 102 to browse information available over the network 160. For example, the browser application 122 may be implemented as a web browser to view information available over the network 160, such as the Internet. In one implementation, the browser application 122 comprises a software program, such as a graphical user interface (GUI), executable by a processor that is configured to interface and communicate with the one or more service provider servers 140 and the identity provider server 180 via the network 160. For example, the user 102 is able to access service provider websites via service provider servers 140 to view and select items or services for purchase, and the user 102 is able to register for products and/or services from service providers 140 by communicating with the identity provider server 180. As described in greater detail herein, when accessing a service provider site as provided by at least one of the service provider servers 140, the user 102 may be asked to fill-in a form (e.g., registration form) prior to making a purchase and/or gaining access to the service. Embodiments of the present disclosure provide a way for the user 102 to quickly fill-in the service provider form by accessing the identity provider server 180.

The client device 120, in one embodiment, may include other applications 128 as may be desired in one or more embodiments to provide additional features available to the user 102. In one example, such other applications 128 may include security applications for implementing client-side security features, programmatic client applications for interfacing with appropriate application programming interfaces (APIs) over the network 160 or various other types of generally known programs and/or applications.

The one or more service provider servers 140, in various embodiments, may be maintained by one or more service providers (i.e., social networking sites, service sites, merchant sites, etc.) offering various items, such as products and/or services, which may need registration of user identity information as part of offering the products and/or services to users, such as the user 102, over the network 160. In this regard, each of the one or more service provider servers 140 may include a database 142 for identifying available products and/or services, which may be made available to the client device 120 for viewing and purchase by the user 102.

Each of the one or more service provider servers 140, in one embodiment, may include a registration application 146, which may be configured as a precondition to offering products or services to the user 102. In this regard, the registration application 146 may be configured to accept identity information from the user 102 and/or from identity provider server 180 over the network 160. When accessing a registration page of at least one of the service provider servers 140, the user 102 may be asked to fill-in a form (e.g., registration form) prior to checking out. As described in greater detail herein, embodiments of the present disclosure provide a way for the user 102 to quickly fill-in the service provider form by accessing the identity provider server 180.

In one embodiment, each of the one or more service providers having a related service provider server 140 may need to establish a service provider account with the identity provider server 180. When establishing a service provider account, each of the one or more service providers may need to provide business information, such as first name, last name, address, social security number, date of birth, phone number, email address, etc., and financial information, such as banking information, service provider account information, credit card information, payment processing information, etc.

In various embodiments, as discussed herein, each of service provider servers 140 may be associated with a particular link (e.g., a link, such as a URL (Uniform Resource Locator) to an IP (Internet Protocol) address). In this regard, the identity provider server 180 may optionally redirect the browser application 122 to an appropriate webpage and/or service provider site of the service provider server 140 to facilitate purchase of a corresponding item and/or service available from at least one of the service provider servers 140.

The identity provider server 180, in one embodiment, may be maintained by an online identity provider, which may provide processing for online financial and information transactions on behalf of the user 102 to an operator of the service provider server 140. As such, the identity provider server 180 includes at least one identity application 182, which may be adapted to interact with the client device 120 and/or each of the service provider servers 140 over the network 160 to facilitate the purchase of items, products and/or services by the user 102 from the service provider server 140. In one example, the identity provider server 180 may be provided by PayPal, Inc. of San Jose, Calif., USA.

The identity provider server 180, in one embodiment, may be configured to maintain a plurality of user and service provider accounts in an account database 184, each of which may include account information 186 associated with individual users, including the user 102, and the one or more service providers associated with the service provider servers 140. For example, account information 186 may include identity information of the user 102 and service providers 140, such as one or more full names, street addresses, email addresses and phone numbers, or other types of financial information, which may be used to facilitate online transactions between the user 102 of the client device 120 and one or more service providers associated with the service provider servers 140. As such, the identity application 182 may be configured to interact with the one or more service provider servers 140 on behalf of the user 102 during a transaction with the registration application 146 without requiring the user 102 to provide account information 186 directly to the service provider server 180. In various embodiments, the methods and systems described herein may be modified to accommodate users and/or service providers that may or may not be associated with at least one existing user account and/or service provider account, respectively.

In one implementation, the user 102 has identity attributes stored with the identity provider 180, and the user 102 has credentials to authenticate or verify identity with the identity provider 180. User attributes may include personal information (e.g., user name, password, photograph image, biometric id, residence address, social security number, phone number, email address, etc.) and banking information (e.g., banking institution, credit card issuer, user account numbers, security information, etc.). In various implementations, one or more user identity attributes may be passed to the identity provider server 180 as part of a user form-fill request, and the user attributes may be used by the identity provider server 180 to associate the user 102 with a particular user account maintained by the identity provider server 180.

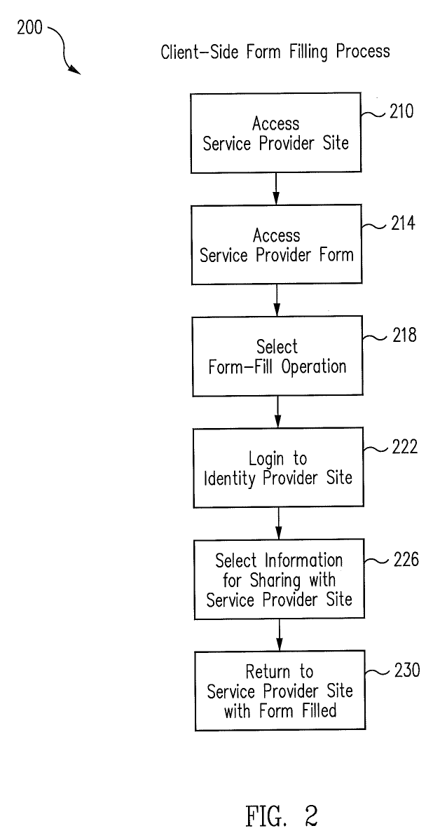

FIG. 2 shows one embodiment of a method 200 for facilitating a client-side online information sharing transaction with the identity application 182 in reference to the client device 120. As previously discussed, the identity application 182 allows the identity provider server 180 to share selected information of the user 102 with the service provider servers 140 when permission is granted by the user 102. As such, the identity application 182 is adapted to forward user identity information to service provider site as requested by the user 102 from the client device 120.

In one implementation, the user 102 may run the browser application 122 on the client device 120 to access at least one service provider website via a related service provider server 140 (block 210) to search and view one or more items, products, and/or services for purchase. Prior to making a purchase, the user 102 may be prompted to access and fill-in a form (e.g., a registration form) on the service provider site (block 214). The user 102 may select a form-fill operation by clicking on, for example, a form-fill GUI button (block 218) and login to a identity provider site for filling-in the service provider form (block 222). Next, the user 102 selects particular information for sharing with the service provider 140 (block 226). For example, the user 102 may select particular personal information for sharing, such as first name, middle name or initial, last name, residence addresses, one or more phone numbers (e.g., home, work and/or cell phone numbers), social security number, date of birth, email address, and financial information, such as banking information and credit card information. After selecting the information for sharing, the user 102 returns to the service provider site by clicking on, for example, a share info GUI button, and the service provider form is filled-in with the information selected for sharing by the user 102 (block 230).

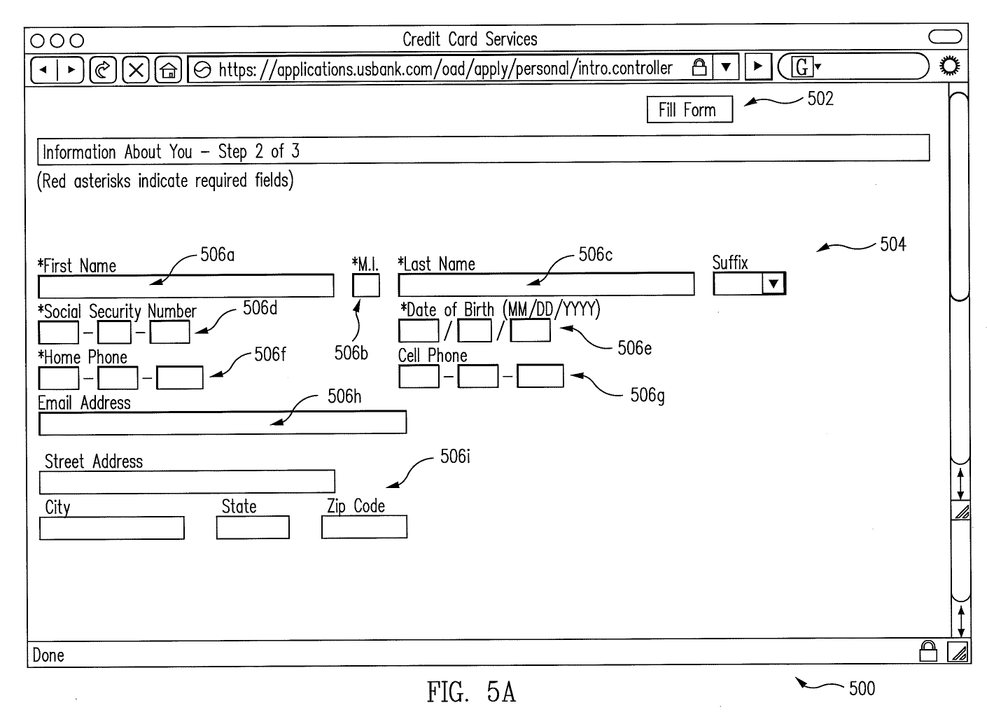

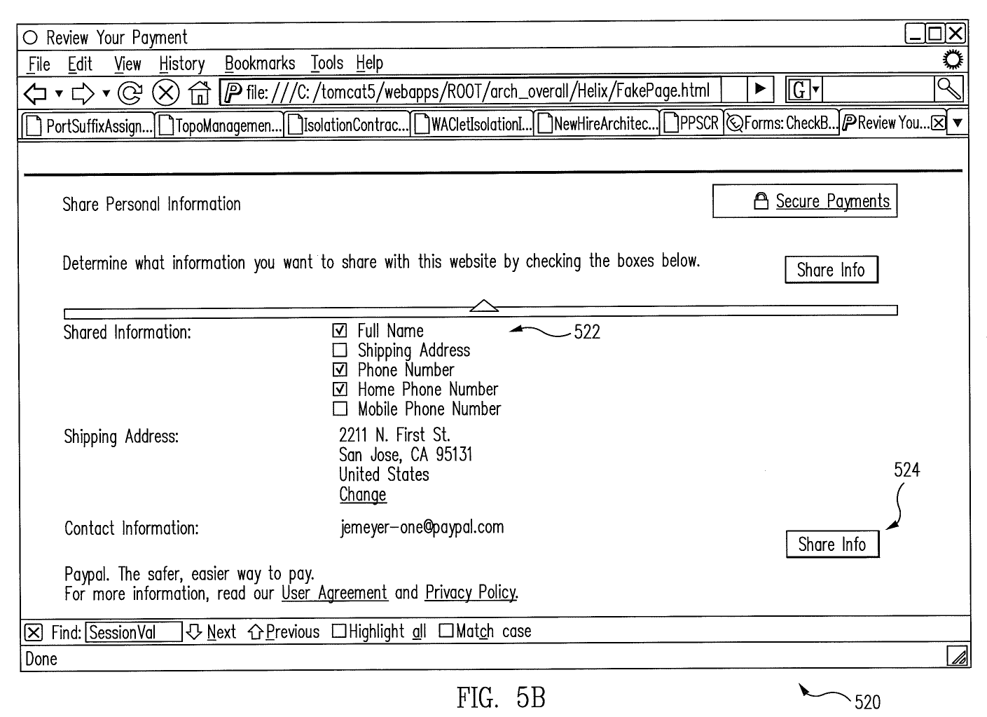

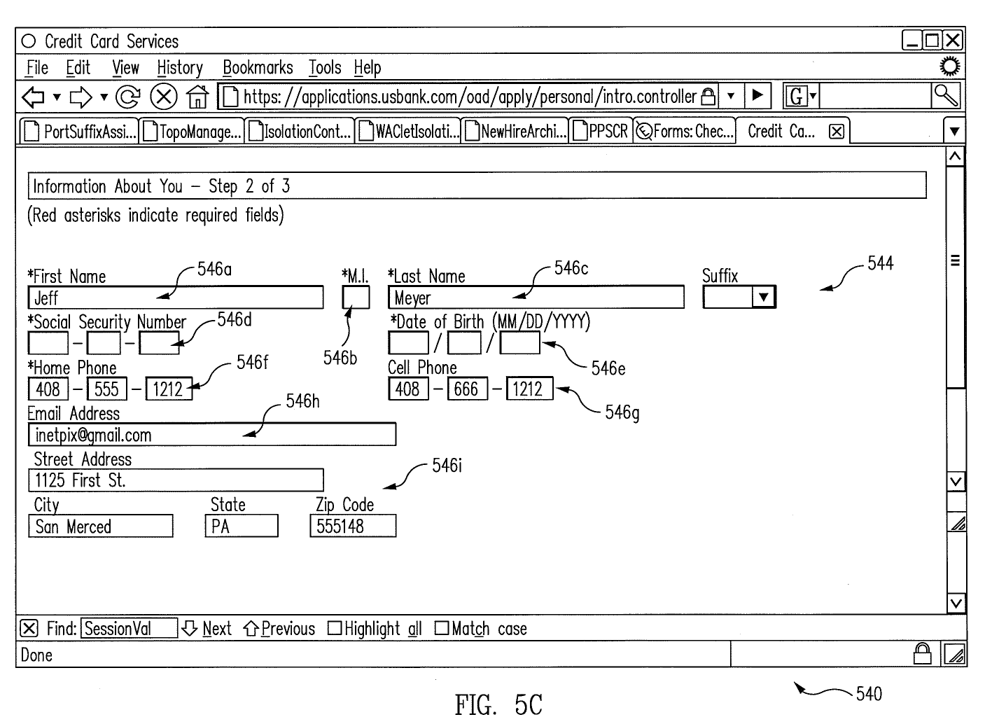

In one implementation, as shown in FIG. 5A, if the service provider 140 has an account with the identity provider server 180, then the service provider site 500 may have a service provider form 504 with a link (e.g., a form-fill GUI button 502) to a identity provider site 520 of FIG. 5B that allows the user 102 to select information 522 for sharing with the service provider site 500. Once the user 102 selects the shared information, as shown in FIG. 5B, the user 102 clicks on another link (e.g., a share info GUI button 524) to return to the service provider site 540, as shown in FIG. 5C, for filling-in the service provider form 544 with the shared information as selected and given permission by the user 102.

Referring to FIG. 5A, the service provider form 504 of the service provider site 500 includes one or more fields 506 for input of information related to the user 102. For example, the service provider form 504 may prompt for user input of a first name 506a, a middle initial 506b, a last name 506c, a social security number 506d, a date of birth 506e, a home phone number 506f, a cell phone number 506g, an email address 506h, and/or residence address information 506i (i.e., a street address, state and zip code).

Referring to FIG. 5C, the service provider form 504 of the service provider site 500 includes one or more fields 546 for input of information related to the user 102. For example, the service provider form 504 includes fields 546 for input of a first name 546a, a middle initial 546b, a last name 546c, a social security number 546d, a date of birth 546e, a home phone number 546f, a cell phone number 546g, an email address 546h, and/or residence address information 546i (i.e., a street address, state and zip code). It should be appreciated that, as shown in FIG. 5C, not every field has to filled, wherein the user 102 selects the fields of the form (e.g., user selectable information 522) for input from the identity provider site 520 of FIG. 5B.

In various implementations, upon user instruction, the identity provider server 180 redirects the user 102 to the service provider site to provide the service provider with the information selected for sharing by the user 102. Accordingly, the identity provider 180 may pass one or more user identity attributes to the service provider 140 as part of redirecting the user 102 back to the service provider site after confirming with the user 102 the set of information to share. In various aspects, the service provider site may participate directly in filling the form by providing a form-fill link (e.g., form-fill button 502 of FIG. 5A) for selection by the user 102 and/or providing appropriate handling logic on the service provider site when redirects for form-filling are passed by the identity provider 180.

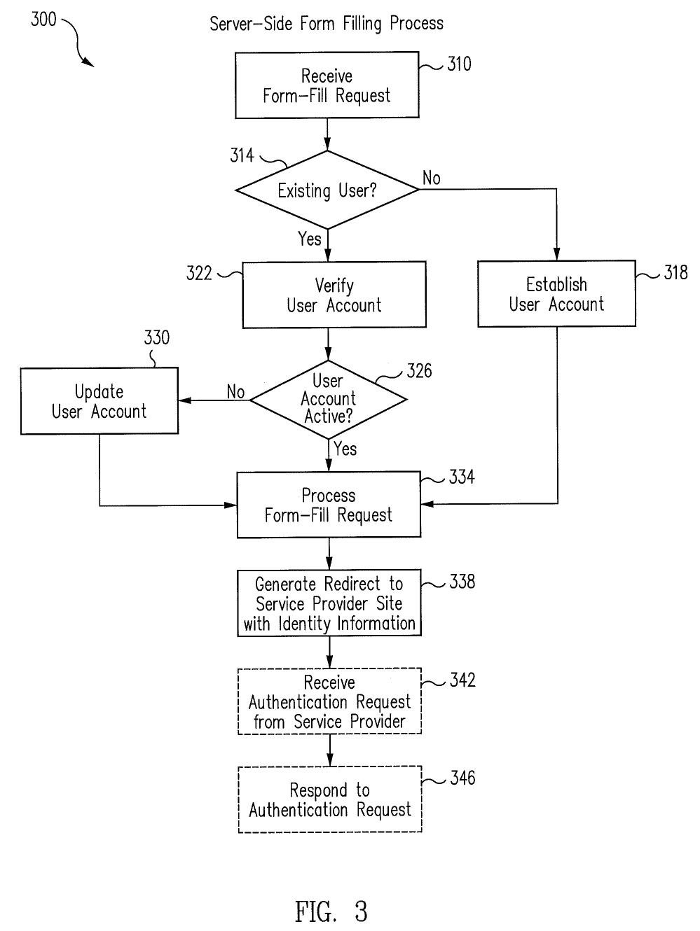

FIG. 3 shows one embodiment of a method 300 for facilitating an online information transaction in reference to the identity provider server 180. As previously discussed, the identity application 182 allows the identity provider server 180 to share selected information of the user 102 with the service provider servers 140 as permitted by the user 102. As such, the identity application 182 is adapted to transmit identity information to a service provider site as requested by the user 102 from the client device 120.

In one implementation, the identity provider server 180 receives a form-fill request from the user 102 via the client device 120 (block 310). As previously described in reference to FIGS. 2 and 5A, the user 102 may select the form-fill operation by clicking on, for example, a form-fill GUI button and login to the identity provider site for filling-in the service provider form. Once the form-fill request is received, the identity provider server 180 determines whether the user 102 is an existing user having an established user account 184 by, for example, checking a user account list in a user account database (block 314). If the user 102 does not have an established user account, then the identity provider server 180 prompts the user 102 to establish a user account 184 by providing user information 186 (block 318). Next, the identity provider server 180 processes the form-fill request provided by the user (block 334).

Otherwise, if the user 102 is determined to be an existing user by the identity provider server 180 (block 314), then the identity provider server 180 verifies the user account and user identification information of the user 102 via a login (block 322). For example, as during login, the user 102 may be prompted to provide user credentials like a login and password to access the user's account and complete the online information transaction. Next, the identity provider server 180 may determine if the user account is current and active (block 326). In some instances, a user's account information may need to be updated, and thus, the identity provider server 180 may prompt the user 102 to update user account information 186 in the user account 184 for the user 102 (block 330). If the user account 184 is current and active, then the identity provider server 180 processes the form-fill request (block 334). It should be appreciated by those skilled in the art that the identity provider server 180 may cancel the online information transaction at any point in the process if it is determined that the user 102 enters wrong information or the user 102 is trying to access information with criminal intent.

In one implementation, the identity provider server 180 processes the form-fill request by allowing the user 102 to select particular information to share with the service provider site, as shown and described in reference to FIG. 5B. The selected information for sharing may include information related to the user 102 including a full name, a residence address, a phone number (e.g., home, work and/or cell phone number), etc.

Next, upon user instruction, the identity provider server 180 redirects the user 102 to the service provider site to provide the service provider with the information selected for sharing by the user 102 (block 338). In various implementations, the identity provider 180 passes one or more user identity attributes to the service provider 140 as part of redirecting the user 102 back to the service provider site after confirming with the user 102 the set of information to share.

Next, once the service provider 140 receives this information from the identity provider 180, the service provider 140 may chose to either use the received information as is, or the service provider 140 may optionally provide an authentication request to the identity provider 180 requesting that the information received be authenticated by the identity provider 180 (block 342). Next, the identity provider 180 optionally responds to the authentication request by providing authentication information to the service provider 140 for the user information (block 346). After receiving authentication information, the service provider 140 regenerates the form and fills-in the form with the shared information selected by the user 102. For example, as shown in FIG. 5C, the service provider form 542 is filled-in with shared information selected by the user 102.

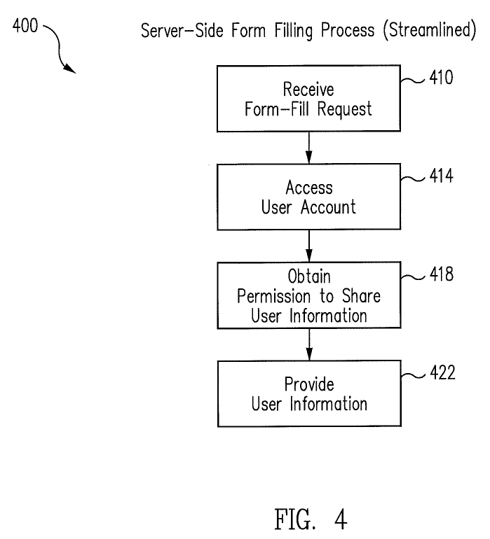

FIG. 4 shows one embodiment of a streamlined method 400 for facilitating an online information transaction in reference to the identity provider server 180. The method 400 of FIG. 4 is a streamlined version of the method 300 of FIG. 3, wherein like operations and/or actions may be interchanged without departing from the scope of the present disclosure.

In one implementation, the identity provider server 180 receives a form-fill request from the user 102 via the client device 120 (block 410). Next, the identity provider server 180 accesses an account associated with the user 102 (block 414). Next, the identity provider server 180 processes the form-fill request provided by the user by obtaining permission from the user 102 to share information with one or more service provider sites (block 418). Next, upon user instruction, the identity provider server 180 provides the information selected for sharing by the user 102 to the service provider site (block 422). Once received, the service provider 140 may fill-in the form with the user information selected for sharing.

In various embodiments, there are varying degrees of authentication that may be offered to the service provider 140. In one implementation, no verification may be requested, wherein the user information passed from the identity provider 180 may be directly used by the service provider 140. For example, this may be suitable if the service provider 140 does not have strong business dependence on this information and may include any information the user may have chosen to directly enter on the form.

In another implementation, confirmation from the identity provider 180 that the passed user information is from the identity provider 180. For example, since the redirect itself may be subject to an untrusted party simulating the redirect, the identity provider 180 may provide an additional service directly to the service provider 140 to verify that the user information received via postback is indeed what the identity provider 180 has sent. This may be done by a simple HTTPS request from the service provider 140 to the identity provider 180 with a response indicating whether the information is verified or not.

In still another implementation, additional assertions about accuracy of information may be requested by the service provider 140. For example, the identity provider 180 may perform additional checks against user identity information which it holds. These checks may provide a higher degree of confidence that the registered user information (e.g., phone number, e-mail address, street address, etc.) are in correctly associated with the user 102. In this case, the identity provider 180 may additionally provide status information with the various user identity attributes provided to indicate the level of confirmation, which has been performed (e.g., unconfirmed, basic confirmation, strong confirmation, etc.).

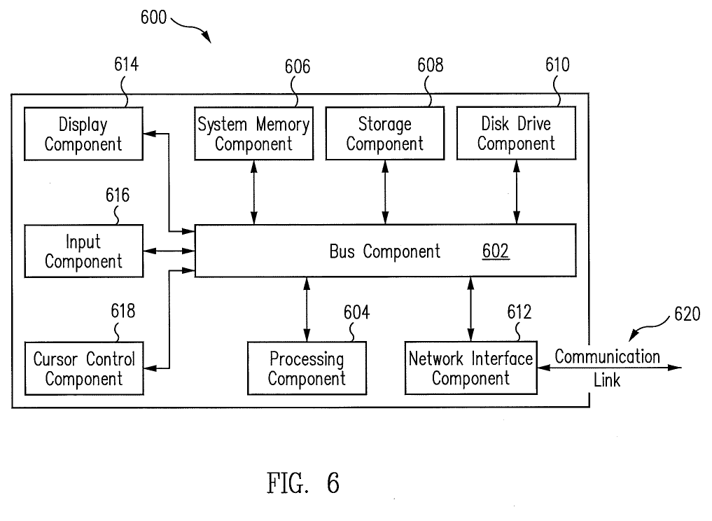

FIG. 6 is a block diagram of a computer system 600 suitable for implementing embodiments of the present disclosure, including the client device 120, the one or more service provider devices 140, and the identity processing device 180. In various implementations, the client device 140 may comprise a personal computing device, such as a personal computer, laptop, PDA, etc., the one or more service provider devices 140 may comprise a network computing device, such as a server, and the identity processing device 180 may comprise a network computing device, such as a server. Thus, it should be appreciated that the devices 120, 140, 180 may be implemented as computer system 600 in a manner as follows.

In accordance with various embodiments of the present disclosure, computer system 600, such as a personal computer and/or a network server, includes a bus 602 or other communication mechanism for communicating information, which interconnects subsystems and components, such as processing component 604 (e.g., processor, micro-controller, digital signal processor (DSP), etc.), system memory component 606 (e.g., RAM), static storage component 608 (e.g., ROM), disk drive component 610 (e.g., magnetic or optical), network interface component 612 (e.g., modem or Ethernet card), display component 614 (e.g., CRT or LCD), input component 616 (e.g., keyboard), and cursor control component 618 (e.g., mouse or trackball). In one implementation, disk drive component 610 may comprise a database having one or more disk drive components.

In accordance with embodiments of the present disclosure, computer system 600 performs specific operations by processor 604 executing one or more sequences of one or more instructions contained in system memory component 606. Such instructions may be read into system memory component 606 from another computer readable medium, such as static storage component 608 or disk drive component 610. In other embodiments, hard-wired circuitry may be used in place of or in combination with software instructions to implement the present disclosure.

Logic may be encoded in a computer readable medium, which may refer to any medium that participates in providing instructions to processor 604 for execution. Such a medium may take many forms, including but not limited to, non-volatile media, volatile media, and transmission media. In various implementations, non-volatile media includes optical or magnetic disks, such as disk drive component 610, volatile media includes dynamic memory, such as system memory component 606, and transmission media includes coaxial cables, copper wire, and fiber optics, including wires that comprise bus 602. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by computer system 600. In various other embodiments of the present disclosure, a plurality of computer systems 600 coupled by communication link 620 (e.g., network 160 of FIG. 1, LAN, WLAN, PTSN, or various other wired or wireless networks) may perform instruction sequences to practice the present disclosure in coordination with one another.

Computer system 600 may transmit and receive messages, data, information and instructions, including one or more programs (i.e., application code) through communication link 620 and communication interface 612. Received program code may be executed by processor 604 as received and/or stored in disk drive component 610 or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure.

Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system for facilitating information transactions over a network, the system comprising:
a first component adapted to communicate with a user via a client device over the network and a service provider via a service provider device over the network; and
a second component adapted to receive a request to fill a form from the user via the client device over the network and provide the service provider device with information related to the user over the network to fill the form as requested by the user.

2. The system of claim 1, wherein the second component is adapted to receive an authentication request from the service provider to authenticate the user information provided the service provider over the network.

3. The system of claim 2, wherein the second component is adapted to provide authentication information to the service provider for the user information in response to the authentication request received from service provider.

4. The system of claim 1, wherein the service provider device provides the form to the client device via the network.

5. The system of claim 1, wherein the client device includes a browser application adapted to allow the user to access the service provider device via the network and view the form for input of information related to the user.

6. The system of claim 1, wherein the form includes one or more fields for input of information related to the user.

7. The system of claim 1, further comprising a third component adapted to store one or more accounts including a user account related to the user, wherein the user account includes information related to the user.

8. The system of claim 1, wherein the information related to the user comprises user selectable information for sharing with the service provider device, and wherein the selectable information includes at least one of a first name, a last name, a residence address, a date of birth, a phone number, and an email address.

9. The system of claim 1, wherein the service provider device comprises a server adapted to communicate with the client device and the second component via the network.

10. The system of claim 1, wherein the system comprises a server.

11. The system of claim 1, wherein the client device comprises a computer adapted to communicate with the service provider device and the second component via the network.

12. A method for facilitating information transactions over a network, the method comprising:
communicating with a user via a client device over the network and a service provider via a service provider device over the network;
receiving a request to fill a form from the user over the network;
accessing a user account related to the user;
processing the request by receiving permission from the user to share information related to the user; and
completing the request by providing the service provider with the information related to the user over the network.

13. The method of claim 12, further comprising receiving an authentication request from the service provider to authenticate the user information provided over the network.

14. The method of claim 13, further comprising providing authentication information to the service provider for the user information in response to the authentication request received from service provider.

15. The method of claim 12, wherein the form includes one or more fields for input of information related to the user.

16. The method of claim 12, wherein processing the request includes user selection of information for sharing.

17. The method of claim 12, wherein processing the request includes receiving permission from the user to share information related to the user.

18. The method of claim 12, further comprising maintaining one or more accounts including a user account related to the user, wherein the user account includes information related to the user including at least one of a first name, a last name, a social security number, a data of birth, a phone number, and an email address.

19. The method of claim 12, further comprising verifying the identity of the user.

20. The method of claim 12, wherein the request to fill the form is received over the network from the service provider device based on an instruction by the user.

21. The method of claim 20, wherein receiving permission from the user includes permission to share information related to the user with the service provider device.

22. The method of claim 12, wherein the service provider device comprises a server adapted to communicate with the client device over the network.

23. The method of claim 12, wherein the client device comprises a computer adapted to communicate with the service provider device over the network.

24. The method of claim 12, wherein the method is executed by a network server.

25. Software encoded in one or more computer readable media and when executed operable to:
communicate with a user via a client device over the network and a service provider via a service provider device over the network;
receive a request to fill a form from the user over the network;
access a user account related to the user;
process the request by receiving permission from the user to share information related to the user; and
complete the request by filling the form with the information related to the user over the network.

26. The software of claim 25, further operable to receive an authentication request from the service provider to authenticate the user information provided over the network.

27. The software of claim 25, further operable to provide authentication information to the service provider for the user information in response to the authentication request received from service provider.
